(19) United States
(12) Patent Application Publication
(10) Pub. No.: US 2014/0278544 A1
(43) Pub. Date: Sep. 18, 2014

(54) AUTOMATED ALERTS FOR MEDICAL INDICATORS

(71) Applicant: Banner Health, Phoenix, AZ (US)

(72) Inventors: Hargobind Khurana, Phoenix, AZ (US); Robert Groves, Phoenix, AZ (US)

(73) Assignee: Banner Health, Phoenix, AZ (US)

(21) Appl. No.: 14/204,843

(22) Filed: Mar. 11, 2014

Related U.S. Application Data
(60) Provisional application No. 61/790,093, filed on Mar. 15, 2013.

(51) Int. Cl. G06F 19/00

(52) U.S. Cl. CPC G06F 19/3406; G06F 19/322
USPC 705/3

(57) ABSTRACT

Automated alerts for medical indicators are provided. Electronic medical records may be stored in memory and monitored. Each electronic medical record may include data regarding a patient and may be updated to reflect current status of the patient. A plurality of alert rules may be provided, each of which identify a set of indicators regarding an elevated risk of death. The monitored electronic medical records and associated updates may be evaluated in light of the applicable alert rules for the patient. It may be determined that one of the electronic medical records matches one of the alert rules. In response, a real-time alert is sent to one or more individuals designated for the patient whose electronic medical record is determined to match one of the alert rules. The real-time alert may be associated with a report indicating the alert rule and associated set of indicators that were the basis for the alert.

### CROSS-REFERENCE TO RELATED APPLICATIONS

The present invention claims the priority benefit of U.S. patent application 61/790,093 filed Mar. 15, 2013, the disclosure of which is incorporated herein by reference.

### BACKGROUND

1. Field of the Invention

The present invention generally relates to medical indicators. More specifically, the present invention relates to automated alerts for medical indicators.

2. Description of the Related Art

Record-keeping practices in the medical profession may vary among the various practices, hospitals, clinics, and other settings where patients may receive medical care. There is presently a trend towards digitizing medical records and storing such medical records in electronic form. Electronic records are not only more easily portable, but may be easily made available to multiple practitioners involved in treating a patient, regardless of time of day or location of the practitioner.

Presently available electronic medical records may be generated upon patient intake and include such basic information as age, height, weight, personal and family medical history, pre-existing medical conditions, and any other medically relevant patient statistics known in the art. Over time, however, medical practitioners may add updates, including new diagnoses, new conditions, and otherwise update the medical information in the electronic medical record.

Despite the involvement of technology in record-keeping however, present medical systems still rely on human practitioners to identify any problems or adverse developments that occur in a patient. While necessary to some extent, such reliance becomes more difficult when there are large numbers of patients and further introduces human error. It may also be extremely time-consuming. This problem is further exacerbated where certain symptoms or changes may have both benign and problematic significance based on other factors. It becomes difficult to prioritize the monitoring of such conditions, especially if they be common in well patients, as well as patients who are at an elevated risk of death.

There is, therefore, a need in the art for improved systems and methods for automated alerts for medical indicators.

### SUMMARY OF THE CLAIMED INVENTION

Systems and methods for automated alerts for medical indicators are provided. Electronic medical records may be stored in memory and monitored. Each electronic medical record includes data regarding a patient and may be updated to reflect current status of the patient. A plurality of alert rules are provided that each identify a set of indicators regarding an elevated risk of death. Different sets of indicators may be applied based on information regarding the patient (e.g., age, gender). The monitored electronic medical records and associated updates are evaluated in light of the applicable alert rules for the patient. It may be determined that one of the electronic medical records matches one of the alert rules. In response, a real-time alert is sent to one or more individuals designated for the patient whose electronic medical record is determined to match one of the alert rules. The real-time alert may be associated with a report indicating the alert rule and associated set of indicators that were the basis for the alert.

Exemplary methods for automated alerts for medical indicators may include monitoring a plurality of electronic medical records including data regarding a patient, where each electronic medical record may be electronically updateable to reflect current status of the patient. Methods may further include storing a plurality of alert rules that each identifies a set of indicators regarding an elevated risk of death, executing instructions to evaluate the electronic medical records and associated updates in light of the stored rules, and to determine that one of the electronic medical records matches one of the alert rules. Further, methods may include sending a real-time alert to one or more individuals designated for the patient whose electronic medical record is determined to match one of the alert rules. The real-time alert may be associated with a report indicating the alert rule and associated set of indicators that were the basis for the alert.

Various embodiments may further include systems for automated alerts for medical indicators. Such systems may include one or more databases that store a plurality of electronic medical records in memory and a plurality of alert rules in memory, as well as a server comprising a processor that executes instructions to monitor the plurality of electronic medical records and to evaluate the electronic medical records and associated updates in light of the stored rules, and to determine that one of the electronic medical records matches one of the alert rules. Such a server may further include a communication interface that sends a real-time alert to one or more individuals designated for the patient whose electronic medical record is determined to match one of the alert rules. The real-time alert associated with an report indicating the alert rule and associated set of indicators that were the basis for the alert.

Embodiments of the present invention may further include non-transitory computer-readable storage media that have embodied a program or executable instructions to perform a method for automated alerts for medical indicators, as discussed herein.

### BRIEF DESCRIPTION OF THE FIGURES

FIG. 1 is an exemplary network environment in which a system for automated alerts for medical indicators may be implemented.

FIG. 2 is a flowchart illustrating an exemplary method for automated alerts for medical indicators.

FIG. 3 is also a flowchart illustrating a specific implementation of a method for automated alerts for medical indicators.

### DETAILED DESCRIPTION

Systems and methods for automated alerts for medical indicators are provided. Electronic medical records may be stored in memory and monitored. Each electronic medical record includes data regarding a patient and may be updated to reflect current status of the patient. A plurality of alert rules are provided that each identify a set of indicators regarding an elevated risk of death. Different sets of indicators may be applied based on information regarding the patient (e.g., age, gender). The monitored electronic medical records and associated updates are evaluated in light of the applicable alert rules for the patient. It may be determined that one of the electronic medical records matches one of the alert rules. In response, a real-time alert is sent to one or more individuals designated for the patient whose electronic medical record is determined to match one of the alert rules. The real-time alert may be associated with a report indicating the alert rule and associated set of indicators that were the basis for the alert.

FIG. 1 is an exemplary network environment 100 in which a system for automated alerts for medical indicators may be implemented. Such a network environment may include an electronic communication network 110, one or more user devices 120A-C, and one or more servers 130.

Devices in the network environment may communicate with each other via communications network 110. Such a communication network 110 may be a local, proprietary network (e.g., an intranet) and/or may be a part of a larger wide-area network (e.g., the cloud). The communications network 110 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. Communications network 110 allows for communication between the various components of network environment 100.

Medical practitioners may use any number of different electronic user devices 120A-C to access and update electronic medical records. In addition, such user devices 120A-C may also be used to communicate real-time alerts and/or provide reports regarding the same. Such user devices may include general purpose computers, mobile phones, smartphones, personal digital assistants (PDAs), paging systems, portable computing devices (e.g., laptop, netbook, tablets), desktop computing devices, handheld computing device, or any other type of computing device capable of communicating data over communication network.

User devices 120A-C may also be configured to access data from other storage media, such as memory cards or disk drives as may be appropriate in the case of downloaded services. User devices 120A-C may further include standard hardware computing components such as network and media interfaces, non-transitory computer-readable storage (memory), and processors for executing instructions that may be stored in memory. Some user devices 120A-C may include or allow for tasks and applications that are specific to and optimized to a particular operating system (e.g., Microsoft Windows® environment, Apple iOS® environment).

In some instances, medical information may be automatically gathered from various medical devices used to monitor patients and sent electronically (e.g., over the communication network 110) to one of the component devices in the network environment 110. Some medical devices may already have communications capabilities, and those medical devices that do not may be coupled to an communications adaptor that allows for communication of information (e.g., to server 130).

Server 130 may include any type of server or other computing device as is known in the art, including standard hardware computing components such as network and media interfaces, non-transitory computer-readable storage (memory), and processors for executing instructions or accessing information that may be stored in memory. The functionalities of multiple servers may be integrated into a single server, or server services may be distributed over multiple servers. Any of the aforementioned servers (or an integrated server) may take on certain client-side, cache, or proxy server characteristics. These characteristics may depend on the particular network placement of the server or certain configurations of the server.

A server 130 may be associated with a particular medical practice and located in the same local network as user devices. Alternatively, the server may be located remotely (e.g., in the cloud) and may be associated with a third party that provides services in accordance with embodiments of the present invention. In some instances, the services may be provided via software (e.g., software as a service) downloaded from server to one or more user devices. Updated software may similarly be downloaded as the updates become available or as needed.

The server 130 may further be associated with or have access to one or more databases 140 storing the electronic medical records. Similar to the server 130, such a database 140 may be local or located remotely from the particular medical practice treating the patients whose electronic medical records are being stored. As noted above, medical practitioners may use any number of user devices 120A-C to capture and/or enter current information regarding a patient and update the associated electronic medical record. For example, nurses may periodically measure a patient's vital signs and observe other symptoms. Such measurements, observations, and other types of updates to the electronic medical record may then be sent and stored in the databases 140 where the server 130 may monitor the electronic records stored in the database(s) and evaluate such records (and their updates) in light of alert rules on a real-time or near real-time basis.

Alert rules are defined sets of indicators that are indicative of an elevated risk of death. The cause of death may include any variety of conditions (e.g., sepsis). The indicators may or may not necessarily be generally considered related to the cause of death. The set of indicators are, rather, geared towards detecting an elevated risk of death, regardless of cause. As such, when a patient's electronic medical record (and/or its updates) satisfies an alert rule (e.g., meets a certain set of indicators), an alert may be sent to one or more medical practitioners designated for that patient. Such practitioners may include doctors, nurses, specialists, and other individuals associated with the medical treatment of the patient. The alert may be sent in real-time (or near real-time) to the updating of the electronic medical record. Such alerts may be linked to or provided with a report indicating why the alert was sent (e.g., which set of indicators were met).

FIG. 2 is a flowchart illustrating an exemplary method 200 for automated alerts for medical indicators. The method 200 of FIG. 2 may be embodied as executable instructions in a non-transitory computer readable storage medium including but not limited to a CD, DVD, or non-volatile memory such as a hard drive. The instructions of the storage medium may be executed by a processor (or processors) to cause various hardware components of a computing device hosting or otherwise accessing the storage medium to effectuate the method. The steps identified in FIG. 2 (and the order thereof) are exemplary and may include various alternatives, equivalents, or derivations thereof including but not limited to the order of execution of the same.

In method 200 of FIG. 2, a plurality of electronic medical records may be stored in memory and monitored. Further, a plurality of alert rules that each identifies a set of indicators regarding an elevated risk of death may be stored in memory. Further, instructions may be executed to evaluate the electronic medical records and associated updates in light of the stored rules, and to determine that one of the electronic medical records matches one of the alert rules. Then, a real-time alert may be sent to one or more individuals designated for the patient whose electronic medical record is determined to match one of the alert rules. The real-time alert may be associated with an report indicating the alert rule and associated set of indicators that were the basis for the alert.

In step 210, electronic medical records may be stored in database(s) 140 and monitored by server 130. Each electronic medical record may include data regarding a patient and may be updated to reflect the current status of the patient. Such data regarding the patient may include demographic data, such as age or gender, as well as medical data, such as medical history, diagnoses, admission or in/outpatient status (emergency, inpatient acute care), and other medical data known in the art. In addition, updates to the electronic medical records may be received from any variety of user devices 120A-C, including devices that can communicate with traditional or modern medical devices to obtain current data regarding the patient.

In step 220, a plurality of alert rules that identify a set of indicators regarding an elevated risk of death may be stored. Such elevated risk may be due to any variety and combination of causes. Sepsis, for example, may be associated with a number of alert rules (e.g., sepsis related to systemic inflammatory response syndrome or organ dysfunction). FIG. 3 is also a flowchart illustrating a specific implementation of a method for automated alerts for medical indicators related to sepsis. The terms as used in FIG. 3 may be defined below as follows:

| Term(s) in Document | Definition/Description |
|---|---|
| Rule Trigger(s); Evoke | The event causing the rule to evoke (wake up) |
| | which if met, proceeds to the logic (Boolean- |
| | based) then action if logic is met |
| CLOSECHART or SIGNORDER | A generic clinical event that can trigger a rule by |
| | closing a patient's chart or signing any or specific |
| | order(s) |
| Rule Logic | Series of statements are evaluated to be either |
| | true or false using operators such as OR, AND, |
| | and AND NOT or OR NOT. |
| Logged Data | When a rule triggers, the logic is evaluated, then |
| | if the logic is determined to be “true”, it goes to |
| | execution/action or “fires”. This information is |
| | then sent to a data-base (logged) w/patient- |
| | specific information “real-time” and then later, |
| | retrieved. |
| BHCMS_SEPSIS_SIRS | Name of the rule that identifies a Systemic |
| (aka SIRS) | Inflammatory Response Syndrome (SIRS). Rule |
| | triggers upon pre-defined clinical parameters |
| | “real-time”. Action sends a message to the Severe |
| | Sepsis rule (BHCMS_SEPSIS_SEVERE) |
| (BHCMS_SEPSIS_OD) | Name of the rule that identifies Organ |
| (aka OD) | Dysfunction (OD). Rule triggers upon pre- |
| | defined clinical defined clinical parameters “real-time”. Action |
| | sends a message to the Severe Sepsis rule |
| | (BHCMS_SEPSIS_SEVERE). |
| ED | The patients current encounter type is Emergency |
| | Department (ED) |
| IP | The patient's current encounter type is Inpatient |
| | acute care (IP) |
| ED or IP Sepsis Orderset or Careset | A group of orders identified as pertaining to a |
| | particular disease, procedure or car. These care |
| | sets (aka order sets) are evidence-based and when |
| | signed, automatically placed the patient into the |
| | ED or IP denominator. |
| Sepsis Dx | Sepsis diagnosis. Usually referring to the |
| | “Sepsis” diagnosis is automatically being added |
| | to the patient's medical record |
| ED_DEN or IP_DEN or *DEN rules | Abbreviation for the rules that place the patient |
| (aka BHCMS_SEPSIS_ED_DEN and | into the sepsis denominator. ED* indicates it is |
| BHCMS_SEPSIS_IP_DEN) | attributed to the Emergency Department (ED) |
| | population and IP* is attributed to the Acute |
| | Care/inpatient population (IP). |
| ED Sepsis Alert | In the Emergency Department (ED), a capitol, |
| | bold red “S” is automatically added to the |
| | emergency department (ED) patient Tracking |
| | Board. |
| Tracking Board | The Tracking Board is part of the Emergency |
| | Department's EMR and is a view displaying all |
| | patients′currently being treated at that facility. |
| | Icons are used to provide care-givers at a glance, |
| | patient-specific information. |
| Severe Sepsis | SIRS and OD rules fire, a message is sent to the |
| (aka BHCMS_SEPSIS_SEVERE) | severe sepsis rule. This rule references the log |
| | data and if the SIRS and OD have fired within the |
| | last 8 hours, the severe sepsis rule |
| | (BHCMS_SEPSIS_SEVERE) |
| | Fires. The definition of Severe Sepsis is any new, |
| | acute organ dysfunction secondary to infection |
| | (NOT limited to sepsis-induced |
| | hypotension/shock). |
| Severe Sepsis Notification | The Severe Sepsis rule logic evaluates the |
| | patient's encounter type. When the severe Sepsis |
| | rule fires and the patient is determined to be from |
| | the emergency department, a message is sent to |
| | the *ED_DEN rule. If the severe sepsis rule |
| | determines the patient is an inpatient, a message |
| | is sent to the *IP_DEN rule. If the *IP_DEN rule |
| | fires, then the order “Severe Sepsis Notification” |
| | is placed |
| ED OPENCHART | This refers to the provider on-screen notification |
| | that appears after the patient has been placed into |
| | the ED sepsis denominator by the rule |
| | BHCMS_SEPSIS_ED_DEN. The notification lets |
| | the provider know the patient is in the |
| | denominator and allows the provider to select |
| | orders to aid in the treatment of the septic patient. |
| ED_REM_DEN or IP_REM_DEN or | Rule that removes the patient from the sepsis |
| *REM_DEN rules | denominator. The *REM_DEN rules fire when |
| (aka | the ED or IP Severe Sepsis Review form is |
| BHCMS_SEPSIS_ED_REM_DEN | answered “No”. *ED_REM_DEN can only fire |
| and | once per encounter (admission). The |
| BHCMS_SEPSIS IP_REM_DEN) | *IP_REM_DEN can fire multiple times |
| | throughout an encounter however only if the |
| | patient is in the denominator and if discharged, it |
| | has to be less than 8 days from discharge. |
| ED to IP Severe Sepsis Notification | The name of the order placed when an ED patient |
| | is admitted and is in the sepsis denominator. The |
| | ED provider has answered |
| | “Definitely/Potentially” on the ED Severe Sepsis |
| | form. This is a communication order to notify the |
| | inpatient care team of the patient's sepsis status. |
| IP Confirm Sepsis or ED Confirm | The title of the provider on-screen alert that |
| Sepsis | allows the provider to complete the ED or IP |
| | Severe Sepsis Review form. The form is available |
| | through a link in the alert window. The ED |
| | Confirm rule will fire the provider on-screen alert |
| | once departure from the ED is documented. The |
| | IP Confirm alert will not fire until 24 hours has |
| | lapsed from the time the patient was triaged in |
| | the ED if sepsis was determined there; OR 24 |
| | hours after each time an IP_REM_DEN fired |
| | removing the patient from the denominator. If |
| | departure from IP care is decided before the 24 |
| | hours lapse, then the IP Confirm alert will fire to |
| | either confirm sepsis (“Yes”) or remove the |
| | patient from the denominator (“No”). |
| Powerform | Custom forms. |
| (aka form; PF) | |
| eICU | Form of (remote) telemedicine that utilizes state |
| | of the art technology to provide an additional |
| | layer of critical care service to facilities for Critical |
| | Care patients. Critical Care providers and nurses |
| | staff eICU 24/7. |
| Bundle Elements | A provider on-screen alert that can fire between 1 |
| | and 6.75 hours per provider after the patient has |
| | been placed in the denominator. The elements |
| | are defined as the basic immediate treatment for |
| | the severe septic patient. This includes serum |
| | lactic acid (LA), appropriate IV (Intravenous) |
| | antibiotics and Blood Cultures drawn before |
| | antibiotic administration. The on-screen lists the |
| | element(s) missing and provide orders in the alert |
| | for convenience. |
| LA>4 | A provider on-screen alert triggering on signing |
| | any order and the most recent Lactic Acid is >4.0. |
| | The alert offers reminders for essential treatments |
| | on the severely septic patient. Fires within 6.75 |
| | minutes of the ED or IP DEN and once per |
| | provider within 24 hours. |
| ADT Discharge | The actual, official discharge date and time comes |
| | from the organizations |
| | Admission/Discharge/Transfer (ADT) system. |
| Attending in-box | The electronic in-box for providers. The in-box |
| | view appears when the provider opens up the |
| | patient's chart. |
| BI | Business Intelligence is the information |
| | technology building and maintaining the Sepsis |
| | Dashboard. |

As can be seen from the specific example illustrated in FIG. 3, the workflow in implementing an alert rule may further involve a number of secondary rules and may rely on subsequent updates and verification steps.

In step 230, an alert rule may be evaluated to determine whether its associated set of indicators are met. As an initial matter, the particular alert rule(s) being evaluated may have been previously determined to be application to the particular patient. Different alert rules may be determined to be applicable to a particular patients based on a variety of factors. Such factors may include any information included in the electronic medical records, including but not limited to gender, age, emergency status, and inpatient acute status. Alert rules determined to be applicable may be triggered or untriggered for evaluation. Such determination of applicability may be updated as the electronic medical records are updated. Further, as noted above with respect to FIG. 3, certain rules (e.g., secondary rules) may be triggered based upon a determination that the indicators of a first alert rule have been met. Once an alert rule has been determined to be applicable and triggered for evaluation to the particular patient, the current electronic medical records may be evaluated to determine whether such information meets the indicators associated with the triggered alert rules.

If the indicators of the alert rules are not met, the method may proceed to step 240, in which updates to the electronic records of the patient may be received and evaluated against the alert rules again in step 230. The updates may not only change the medical information associated with the patient, but may also change which rules may be applicable or trigger secondary alert rules.

If the indicators of the alert rules are met, the method may proceed to step 250, in which a real-time alert may be sent to one or more designated recipients. Such recipients may be designated medical professionals and/or other caregivers of the patient. Such alerts may include a report with an explanation of which alert rule was triggered, as well as the associated indicators that were met. In addition to the alerts, notifications may be sent regarding a care regimen or need for update. The timing of such notifications may be adjusted based on subsequent updates regarding the patient.

Information regarding the alerts may further be logged for evaluation regarding the rule. In addition, such information may be used to generate a patient tracking board display which may provide medical professionals and caregivers a view of real-time status of multiple patients. Such status may be provided via identifiers of which alert rules have been triggered and/or which indicators have been met.

The present invention may be implemented via one or more applications that may be downloaded, installed, and operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method for automated alerts for medical indicators, the method comprising:
monitoring a plurality of electronic medical records stored in memory, each electronic medical record comprising data regarding a patient, each electronic medical record updateable to reflect current status of the patient;
storing a plurality of alert rules in memory, wherein each alert rule identifies a set of indicators regarding an elevated risk of death;
executing instructions stored in memory, wherein execution of the instructions by a processor:
evaluates the electronic medical records and associated updates in light of the stored rules, and
determines that one of the electronic medical records matches one of the alert rules; and
sending a real-time alert to one or more individuals designated for the patient whose electronic medical record is determined to match one of the alert rules, the real-time alert associated with a report indicating the alert rule and associated set of indicators that were the basis for the alert.

2. The method of claim 1, further comprising determining which of the stored alert rules are currently applicable to the patient based on the electronic records and triggering or untriggering the evaluated alert rules for the patient based on applicability.

3. The method of claim 2, further comprising updating the determination of applicability based on the associated updates to the electronic medical records of the patient.

4. The method of claim 3, further comprising sending a notification to the one or more individuals designated for the patient regarding a care regimen or need for update, wherein timing of the notification is based on the triggered alert rules.

5. The method of claim 4, wherein the timing of the notification is adjusted based on updates to the electronic medical records of the patient.

6. The method of claim 2, wherein different alert rules are associated with different patient status types, and wherein the determination of applicability is further based on status type of the patient.

7. The method of claim 6, wherein the status type of the patient comprises one of gender, age, emergency, or inpatient acute care, and wherein the selected alert rule is specific to the determined status type.

8. The method of claim 2, further comprising triggering a secondary alert rule for the associated patient upon determination of the match.

9. The method of claim 1, further comprising logging information about the real-time alert and the associated set of indicators that were the basis for the alert.

10. The method of claim 1, further comprising generating a patient tracking board display that includes information regarding real-time status of a plurality of patients.

11. The method of claim 10, wherein the patient tracking board display includes identifiers of which alert rules have been triggered for each patient and/or which indicators have been met.

12. The method of claim 1, wherein at least one alert rule is related to identifying sepsis, and wherein the set of indicators associated with the at least one alert rule related to sepsis are associated with systemic inflammatory response syndrome or organ dysfunction.

13. A system for automated alerts for medical indicators, the system comprising:
one or more databases that store:
a plurality of electronic medical records in memory, each electronic medical record comprising data regarding a patient, each electronic medical record updateable to reflect current status of the patient, and
a plurality of alert rules in memory, wherein each alert rule identifies a set of indicators regarding an elevated risk of death; and
a server comprising:
a processor that executes instructions stored in memory, wherein execution of the instructions by the processor:
monitors the plurality of electronic medical records stored in memory,
evaluates the electronic medical records and associated updates in light of the stored rules, and
determines that one of the electronic medical records matches one of the alert rules; and
a communication interface that sends a real-time alert to one or more individuals designated for the patient whose electronic medical record is determined to match one of the alert rules, the real-time alert associated with a report indicating the alert rule and associated set of indicators that were the basis for the alert.

14. The system of claim 13, further comprising one or more user devices that receive the associated updates to the electronic medical record and sends to the one or more databases for updating of the stored electronic medical records.

15. The system of claim 13, further comprising one or more medical devices that directly monitors the patient for the associated updates to the electronic medical record and sends to the one or more databases for updating of the stored electronic medical records.

16. The system of claim 13, further comprising a screen for displaying a patient tracking board that includes indicators of which alert rules have been triggered for each patient.

17. A non-transitory computer-readable storage medium, having embodied thereon a program executable by a processor to perform a method for automated alerts for medical indicators, the method comprising:
monitoring a plurality of stored electronic medical records, each electronic medical record comprising data regarding a patient, each electronic medical record updateable to reflect current status of the patient;
storing a plurality of alert rules, wherein each alert rule identifies a set of indicators regarding an elevated risk of death;
evaluating the electronic medical records and associated updates in light of the stored rules;
determining that one of the electronic medical records matches one of the alert rules; and
sending a real-time alert to one or more individuals designated for the patient whose electronic medical record is determined to match one of the alert rules, the real-time alert associated with a report indicating the alert rule and associated set of indicators that were the basis for the alert.
